(19) United States
(12) Patent Application Publication
(10) Pub. No.: US 2007/0242229 A1
(43) Pub. Date: Oct. 18, 2007

(54) METHOD AND APPARATUS FOR BLOCKING LASER BEAMS USING HUMAN BODY SENSOR IN IMAGE PROJECTOR

(76) Inventors: Ji-Won Kim, Seongnam-si (KR); Yong-Chan Keh, Seoul (KR); Jin-Wook Kwon, Suwon-si (KR)

Correspondence Address: CHA & REITER, LLC, 210 ROUTE 4 EAST STE 103, PARAMUS, NJ, 07652, US

(21) Appl. No.: 11/673,619

(22) Filed: Feb. 12, 2007

(30) Foreign Application Priority Data
Apr. 13, 2006 (KR) 2006-33709

(51) Int. Cl. G03B 21/00

(52) U.S. Cl. 353/31

(57) ABSTRACT

An apparatus and method for blocking laser beams using a human body sensor in an image projector includes the steps of: monitoring, using the human body sensor, in a projected direction in which the image projector projects on a screen laser beams corresponding to a predetermined image; when an obstacle is sensed on the screen of the projected direction, measuring a temperature value of the obstacle by absorbing infrared (IR) rays emitted by the obstacle; comparing the measured temperature value of the obstacle to a pre-set temperature range; and if the measured temperature value of the obstacle is within the pre-set temperature range, blocking the laser beams corresponding to the predetermined image by stopping driving the image projector.

### CLAIM OF PRIORITY

This application claims priority under 35 U.S.C. § 119 to an application entitled “Method and Apparatus for Blocking Laser Beams Using Human Body Sensor in Image Projector,” filed in the Korean Intellectual Property Office on Apr. 13, 2006 and assigned Serial No. 2006-33709, the entire contents of which are incorporated herein by reference.

### BACKGROUND OF THE INVENTION

1. Field of the Invention

The present invention relates generally to an image projector, and in particular, to a method and apparatus for blocking a laser light source module using a human body sensor in various devices (e.g., a mobile communication terminal) having an image projector.

2. Description of the Related Art

A recent increase of the use of an image projector called a projector has resulted in development and marketing activities of various kinds of products. As a result, the projector has been miniaturized, and brightness and color reproducibility of the projector has been improved, and the projector has been included in various devices (e.g., a mobile communication terminal).

In general, the image projector allows users to view an image displayed on a screen by projecting the image onto the screen using a high luminance projection tube as a light source for projecting the image onto the screen. However, with the goals of the improvement of brightness, color reproducibility, ease of modulation by an image signal in mind an image projector using the laser light sources of red (R), green (G) and blue (B) has been proposed.

FIG. 1 illustrates a conventional system in which an image projector using a laser light source module projects an image onto a screen.

Referring to FIG. 1, the conventional system in which an image projector using a laser light source module 110 projects an image onto a screen 130 includes the laser light source module 110, a light modulator unit 120, and the screen 130 onto which lasers are projected.

The laser light source module 110 has a laser set including a red laser R, a green laser G, and a blue laser B, wherein each of the lasers R, G, and B is driven by a laser light source driving voltage source 190.

The light modulator unit 120 includes a modulator (not shown) for modulating laser beams of different colors according to an image signal and an optical system (not shown). The laser beams of different colors are modulated according to an image signal and commonly scanned by a scanning mirror (not shown).

The light modulator unit 120 includes an object lens 121 for projecting the laser beams of different colors generated by the laser light source module 110 onto the screen 130, wherein the laser beams of different colors scanned by the scanning mirror are projected onto the screen 130 via the object lens 121.

An area surrounded by a solid line frame L illustrated in FIG. 1 is an area in which the laser beams are projected, that is an image is projected in the area delimited by the frame L.

The image projector using the laser light source module 110 is better than an image projector using a high luminance projection tube in terms of brightness and color reproducibility and can easily modulate an image signal.

However, the image projector using the laser light source module 110 has a problem regarding safety. For example, an image projector designed for home use may emit laser beams into the eyes of a user while it is in use. The direct emitting of laser beams into the eyes of a user results in a severe danger of eye injury resulting therefrom.

According to the prior art, in order to solve this problem, an apparatus has been suggested for blocking laser beams using a detection wave in the image projector using the laser light source module 110.

FIG. 2 illustrates a conventional system in which an image projector using a laser light source module blocks laser beams using a detection wave.

In FIG. 2, the elements that are the same as or similar to those in FIG. 1 are denoted by the same reference numerals.

Referring to FIG. 2, the conventional system in which an image projector using the laser light source module 110 blocks laser beams using a detection wave includes a detection wave source 140 and a reflected wave sensor 150 as well as the laser light source module 110, the light modulator unit 120, and the screen 130 onto which the laser beams are projected, which are described in FIG. 1.

The detection wave source 140 is disposed on the same line of red (R), green (G), and blue (B) lasers, and a detection wave emitted from the detection wave source 140 is projected on the screen 130 via the object lens 121 of the light modulator unit 120 in the same manner as the laser beams of different colors. An area surrounded by a dotted line frame IR illustrated in FIG. 2 is a projection area of the detection wave. The projection frame IR of the detection wave covers the projection frame L of the laser beams and is larger than the projection frame L of the laser beams, which is illustrated in FIG. 1, so that a user can be detected before the user enters into the projection area of the laser beams. Typically, infrared (IR) rays or ultrasonic waves, which are safe to a human body, are used for the detection wave source 140.

In order to monitor the intensity of the reflected wave, the reflected wave sensor 150 is disposed in a location suitable for detection of a wave reflected by the screen 130. The reflected wave sensor 150 is connected to a switch 170 disposed to turn on or off the voltage source 190 in order to drive or block the R, Q and B lasers if the monitored intensity of the wave reflected by the screen 130 varies. That is, the switch 170 is turned on or off according to a detection signal of the reflected wave sensor 150.

If an obstacle (the user or other obstacle) enters into the projection area delimited by the projection frame IR of the detection wave and the object lens 121, the reflected wave sensor 150 detects the intensity of the wave reflected by the screen 130. When it is determined, based on the detected intensity of the reflected wave, that an obstacle has entered into the projection area, the reflected wave sensor 150 immediately turns off the switch 170 so that the laser beams of the image projector are not emitted.

Thus, since the conventional image projector using the laser light source module 110 blocks the laser beams using the detection wave when an obstacle enters into the projection area, the user can safely use the image projector since the user is not exposed to the laser beams.

However, in the image projector using the laser light source module 110, which blocks the laser beams using the detection wave, when an obstacle enters into the projection area of the detection wave, which is a space delimited by the projection frame IR of the detection wave and the object lens 121, the reflected wave sensor 150 responds to every type of obstacle, and thus, the laser beams are blocked every time any obstacle enters into the projection area of the detection wave.

In this case, even when an obstacle (a thing) not the user enters into the projection area of the detection wave, the laser beams are unnecessarily blocked.

### SUMMARY OF THE INVENTION

Accordingly, the present invention provides a method and apparatus for blocking laser beams using a human body sensor in an image projector, whereby unnecessary blocking of the laser beams can be prevented. Prevention is accomplished by using the human body sensor to monitor a screen of a projected direction in which the image projector projects laser beams corresponding to a predetermined image, and when an obstacle is sensed on the screen in the projected direction, the sensed obstacle is identified and the laser beams are blocked according to the identification result.

According to one aspect of the present invention, there is provided a method of blocking laser beams using a human body sensor in an image projector, the method comprising the steps of: monitoring, using the human body sensor, a screen in a projected direction in which the image projector projects laser beams corresponding to a predetermined image; when an obstacle is sensed on the screen in the projected direction, measuring a temperature value of the obstacle by absorbing infrared (IR) rays emitted by the obstacle; comparing the measured temperature value of the obstacle to a pre-set temperature range to obtain a comparison result; and when the comparison result is within the pre-set temperature range, blocking the laser beams corresponding to the predetermined image by stopping driving the image projector.

### BRIEF DESCRIPTION OF THE DRAWINGS

The above features and advantages of the present invention will become more apparent from the following detailed description when taken in conjunction with the accompanying drawing in which:

FIG. 1 illustrates a conventional system in which an image projector using a laser light source module projects an image onto a screen;

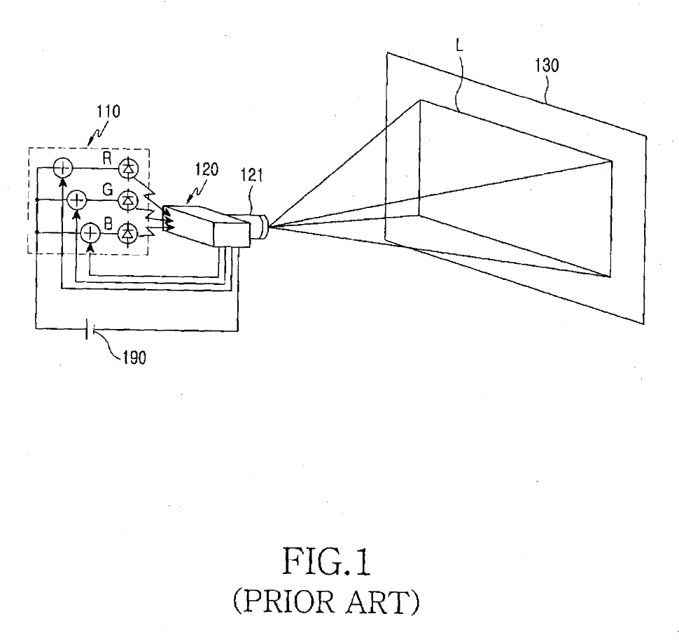

FIG. 2 illustrates a conventional system in which an image projector using a laser light source module blocks laser beams using a detection wave;

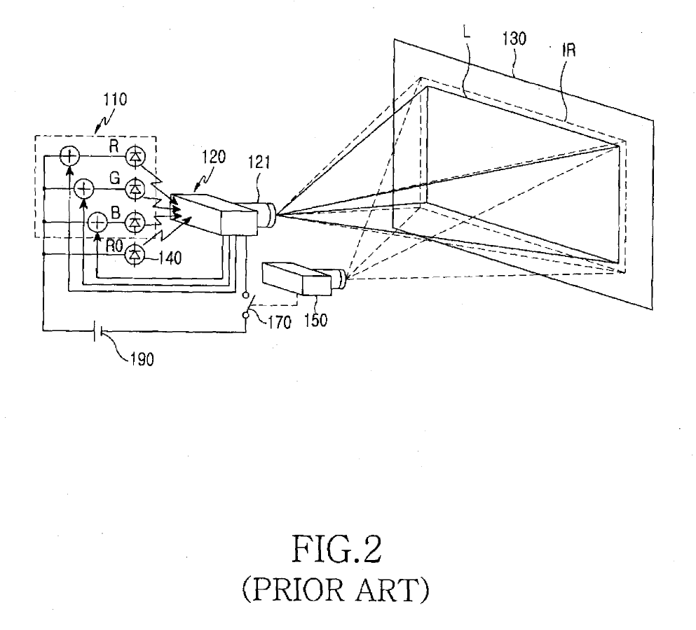

FIG. 3 illustrates a system in which a mobile communication terminal including an image projector projects an image onto a screen according to an exemplary embodiment of the present invention;

FIG. 4 is a block diagram of a mobile communication terminal according to an exemplary embodiment of the present invention; and

FIG. 5 is a flowchart illustrating a method of blocking laser beams using a human body sensor in an image projector according to an exemplary embodiment of the present invention.

### DETAILED DESCRIPTION

Exemplary embodiments of the present invention are described herein below with reference to the accompanying drawings. For the purposes of clarity and simplicity, well-known functions or constructions are not described in detail as they would obscure the invention in unnecessary detail.

In exemplary embodiments of the present invention, a mobile communication terminal among various devices including an image projector is illustrated by way of example only and not in any limiting sense.

In exemplary embodiments of the present invention, the mobile communication terminal indicates a cellular phone, a personal information terminal, a Personal Communication Services (PCS) phone, an International Mobile Telecommunication (IMT)-2000 terminal, a Global System for Mobile Communication (GSM) terminal, or a device providing a communication function for making a phone call or exchanging data while moving, which includes an image projector.

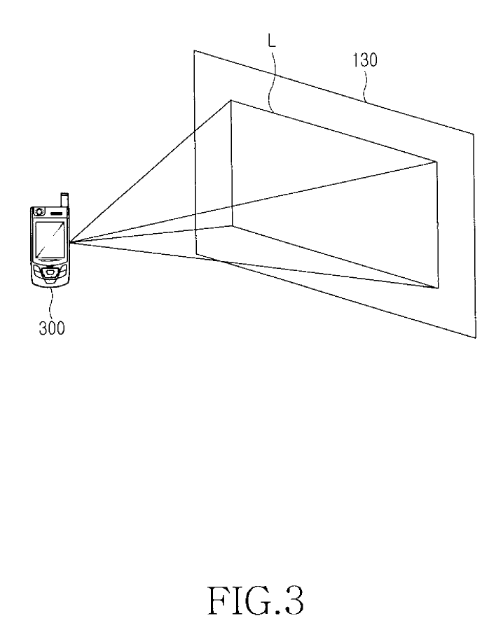

FIG. 3 illustrates a system in which a mobile communication terminal including an image projector projects an image onto a screen according to an exemplary embodiment of the present invention.

Referring to FIG. 3, the system includes a mobile communication terminal 300 and a screen 130 onto which laser beams corresponding to a predetermined image are projected. An area surrounded by a solid line frame L illustrated in FIG. 3 is an area in which the laser beams are projected, wherein an image is projected in the area delimited by the frame L.

The mobile communication terminal 300 according to an exemplary embodiment of the present invention includes an image projector (not shown) for projecting laser beams corresponding to a predetermined image onto the screen 130 and a sensor unit (not shown) for monitoring the screen 130 in a projected direction in which the image projector projects laser beams corresponding to a predetermined image.

The image projector and the sensor unit of the mobile communication terminal 300 are now described in more detail. The image projector included in the mobile communication terminal 300 includes a laser light source module (not shown) and a light modulator unit (not shown) as a configuration of a conventional image projector using a laser light source module.

The laser light source module according to an exemplary embodiment of the present invention has a laser set including a red laser R, a green laser G, and a blue laser B, as a conventional laser light source module. The light modulator unit includes a modulator (not shown) for modulating laser beams of different colors according to an image signal and an optical system (not shown). Thus, the laser beams of different colors are modulated according to the image signal and commonly scanned by a scanning mirror (not shown). The light modulator unit includes an object lens (not shown) for projecting the laser beams of different colors generated by the laser light source module onto the screen 130, wherein the laser beams of different colors scanned by the scanning mirror are projected onto the screen 130 via the object lens.

The sensor unit monitors the screen 130 in a projected direction in which the image projector of the mobile communication terminal 300 projects laser beams corresponding to a predetermined image. A pyroelectric or thermopile sensor, which is an infrared (IR) sensor, is preferably used for the sensor unit.

In general, every object in the natural world emits radiation energy (IR rays) of a unique wavelength, and likewise, a human body emits IR rays of a unique wavelength distinguished from that emitted by other entities. Various kinds of devices can be controlled by sensing the IR rays. For example, an energy saving effect can be obtained by installing a sensor light for sensing IR rays on stairways or corridors and turning on or off the sensor light according to whether a human being exists in a sensing range of the sensor light.

In an exemplary embodiment, when an obstacle is sensed in the projected direction of the screen 130, the sensor unit measures a temperature value of the obstacle by absorbing IR rays emitted by the obstacle. A method of measuring the temperature value of the obstacle is performed by quantifying a voltage proportional to a wavelength of the absorbed IR rays to a Celsius degree. In addition, an optical filter is installed in a window of the sensor unit so that IR rays of a specific wavelength emitted by an obstacle can be absorbed well.

The temperature value of the obstacle, which is measured by the sensor unit, is compared to a pre-set temperature range to obtain a comparison result. When the comparison result indicates that the temperature value is within the pre-set temperature range, laser driving of the image projector is stopped, and thereby the projection of the laser beams corresponding to the predetermined image is blocked.

When the comparison result indicates that the temperature value is outside of the pre-set temperature range, the image projector projects the laser beams corresponding to the predetermined image onto the screen 130.

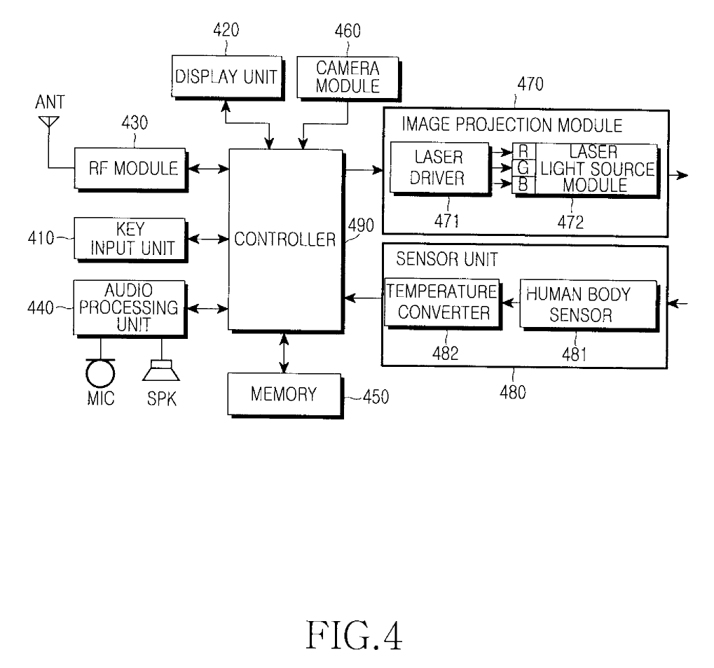

FIG. 4 is a block diagram of a mobile communication terminal 300 according to an exemplary embodiment of the present invention.

Referring to FIG. 4, the mobile communication terminal 300 includes a key input unit 410, a display unit 420, a Radio Frequency (RF) module 430, an audio processing unit 440, a memory 450, a camera module 460, an image projection module 470, a sensor unit 480 all connected to a controller 490.

A configuration of the mobile communication terminal 300 is now described in more detail. The key input unit 410 receives a user operating signal, such as a key input or a speech input, and outputs the user operating signal to the controller 490. The key input unit 410 includes a setting key for blocking laser beams using a human body sensor in the image projection module 470 among keys thereof. The setting key can be a newly assigned existing key or a separate and additional key that is newly included in the mobile communication terminal 300.

The display unit 420 outputs various kinds of display data created by the mobile communication terminal 300 and is preferably comprises a Liquid Crystal Display (LCD) that can sufficiently support resolution of a moving picture output from the mobile communication terminal 300. Herein, when the LCD is implemented using a touch screen scheme, the display unit 203 can operate as an input module.

The controller 490 controls the RF module 430 to transmit and receive speech data, text data, image data, and control data. To do this, the RF module 430 further includes an RF transmitter (not shown) for upstream converting a frequency of a signal to be transmitted and amplifying the signal to be transmitted and an RF receiver (not shown) for low noise amplifying a received signal and downstream converting a frequency of the received signal. In an alternative exemplary embodiment, the RF module 430 includes a modem (not shown) comprising a transmitter for encoding and modulating the signal to be transmitted and a receiver for demodulating and decoding the received signal.

The audio processing unit 440 modulates an electrical signal input through a microphone to speech data, and demodulates encoded speech data input from the RF module 430 to an electrical signal and outputs the electrical signal to a speaker. It is preferable that the audio processing unit 440 includes a codec to convert a digital audio signal input through the RF module 430 to an analog audio signal and converts an analog audio signal input through the microphone to a digital audio signal. The codec includes a data codec for processing packet data and an audio codec for processing an audio signal such as speech.

The memory 450 stores various kinds of information required for control of the operation of the mobile communication terminal 300. In an exemplary embodiment, the memory 450 stores an image to be output to the screen 130 via the image projection module 470.

The camera module 460 preferably includes a lens module (not shown) that is one of exposed or hidden and that captures an image. The camera module 460 also includes a camera sensor (not shown) for converting an optical signal obtained by capturing an image to an electrical signal and a signal processing unit (not shown) for converting the analog image signal received from the camera sensor to digital data. Herein, by way of example only and not in any limiting sense, it is assumed that the camera sensor is a charge coupled device (CCD) sensor, and the signal processing unit is implemented by a digital signal processor (DSP). The camera sensor and the signal processing unit are implemented in one of a single component and separate components.

The image projection module 470 is a module for performing a function of a general image projector in the mobile communication terminal 300 and performs a function of projecting an image input from the controller 490 onto the screen 130.

The image projection module 470 includes a laser driver 471, which receives from the controller 490 a signal for determining whether the image projection module 470 is driven and a laser light source module 472 which projects laser beams corresponding to a predetermined image input from the controller 490 onto the screen 130 when it is determined that the image projection module 470 is driven.

A configuration of the image projection module 470 is now described in more detail. The laser driver 471 determines, according to an enable or a disable signal input from the controller 490, whether the image projection module 470 is driven.

When the enable signal in input from the controller 490, the laser driver 471 drives the image projection module 470 so that the laser light source module 472 projects laser beams corresponding to a predetermined image input from the controller 490 onto the screen 130.

When the disable signal is input from the controller 490 since an obstacle is sensed in the projected direction of the screen 130 in which the image projection module 470 projects laser beams corresponding to a predetermined image, the laser driver 471 stops driving the image projection module 470 so that the projection of the laser beams corresponding to the predetermined image are blocked.

The laser light source module 472 has a laser set including a red laser R, a green laser G, and a blue laser B and projects laser beams corresponding to a predetermined image when the image projection module 470 is driven. The laser light source module 472 includes a modulator (not shown) for modulating laser beams of different colors according to the laser set and an image signal and an optical system (not shown). Thus, the laser beams of different colors are modulated according to an image signal and are commonly scanned by a scanning mirror (not shown). The laser light source module 472 includes an object lens (not shown) for projecting the laser beams of different colors onto the screen 130, wherein the laser beams of different colors scanned by the scanning mirror are projected onto the screen 130 via the object lens.

The sensor unit 480 monitors the screen 130 in a projected direction in which the image projection module 470 projects laser beams corresponding to a predetermined image. The sensor unit 480 includes a human body sensor 481 and a temperature converter 482.

A configuration of the sensor unit 480 is now described in more detail.

When an obstacle is sensed in a projected direction of the screen 130 on which the image projection module 470 projects laser beams corresponding to a predetermined image, the human body sensor 481 absorbs IR rays of the sensed obstacle. The human body sensor 481 has an optical filter (not shown) in a window thereof to absorb IR rays of a specific wavelength emitted from the obstacle.

In an exemplary embodiment, a pyroelectric or thermopile sensor, which is an IR sensor, is used as the human body sensor 481. The pyroelectric sensor is generally manufactured using a dielectric substance showing the pyroelectric effect, wherein the dielectric substance receives IR rays emitted by an object and generates electric charges on the surface thereof due to heat generated by the IR rays, resulting in an output signal of the pyroelectric sensor. The pyroelectric sensor generates an output signal proportional to the intensity of IR rays (wavelength: 6.5 μm˜15 μm) of an object emitting IR rays, including a human body. However, the pyroelectric sensor has a disadvantage of being easily affected by an ambient or operating temperature.

The thermopile sensor is a sensor sensing a temperature using the feedback effect that thermoelectric power is created in proportion to a temperature difference between two different metals forming a closed loop.

The thermopile sensor has advantages of showing a stable response characteristic to direct current radiation, responding to a wide IR spectrum, and requiring neither bias voltage nor bias current. An operational principle of the thermopile sensor is based on the Stefan-Boltzmann's Law, “the energy emitted by a body per unit area and unit time is proportional to the fourth power of the absolute temperature of the body”.

Since technology of the pyroelectric and thermopile sensors, which are IR sensors that can be used as the human body sensor 481 are well known in the art, a detailed description of the pyroelectric and thermopile sensors is omitted.

In an exemplary embodiment, a thermopile sensor is used as the human body sensor 481 in order to quantifiably measure a temperature using an IR wavelength of an obstacle.

If an obstacle is sensed in a projected direction in which the image projection module 470 projects laser beams corresponding to a predetermined image, the human body sensor 481 absorbs an IR wavelength emitted by the sensed obstacle and outputs a voltage proportional the IR wavelength thereof to the temperature converter 482.

The temperature converter 482 receives the voltage output from the human body sensor 481, measures a temperature value of the obstacle using the received voltage, and transmits the measured temperature value to the controller 490.

In an exemplary embodiment, a method for the temperature converter 482 to measure a temperature value of an obstacle is performed by quantifying a voltage proportional to a wavelength of IR rays absorbed from the obstacle to a Celsius degree. Since a method for the temperature converter 482 to quantify a voltage to a Celsius degree is well known by those skilled in the art, a detailed description of the method is omitted.

The controller 490 controls general operation of the mobile communication terminal 300. That is, the controller 490 performs a process according to a number input through the key input unit 410 and a menu selection signal, performs a process according to an externally captured image signal input through the camera module 460, and outputs images required for various operations, which include camera captured images, using one of the display unit 420 and the image projection module 470.

In an exemplary embodiment, when a signal is input for outputting an image selected by the user through the image projection module 470, the controller 490 controls the image projection module 470 to project the image selected by the user onto the screen 130. The image selected by the user indicates one of an image captured by the camera module 460, which is stored in the memory 450 of the mobile communication terminal 300, and an image downloaded from a base station in a wireless manner. The downloaded image is also stored in the memory. If the mobile communication terminal 300 includes a DMB receiving module, a multimedia data image received through a DMB service may be the image selected by the user.

When a signal is input through the key input unit 410 for outputting through the image projection module 470 an image selected by the user, the controller 490 transmits the image selected by the user to the image projection module 470.

The controller 490 controls the sensor unit 480 to determine whether an obstacle exists in a projected direction in which the image projection module 470 projects laser beams corresponding to a predetermined image.

When it is determined that no obstacle exists in a projected direction of the screen 130 on which the image projection module 470 projects laser beams corresponding to a predetermined image, the controller 490 transmits the enable signal to the image projection module 470 so that the image projection module 470 projects laser beams corresponding to a predetermined image selected by the user onto the screen 130.

If it is determined that an obstacle exists in a projected direction of the screen 130 on which the image projection module 470 projects laser beams corresponding to a predetermined image, the controller 490 compares a temperature value of the obstacle input from the sensor unit 480 to a pre-set temperature range, wherein the pre-set temperature range is between 32° C. and 45° C.

In general, the temperature of a human body is 36.5° C. In an exemplary embodiment, a temperature range is set considering a current environmental temperature based on the general human body temperature 36.5° C. However, the pre-set temperature range is not limited to this value but can be changed by a manufacturer or the user of the mobile communication terminal 300.

If the temperature value of the obstacle input from the sensor unit 480 is within the pre-set temperature range, the controller 490 transmits the disable signal to the image projection module 470 so that driving of the image projection module 470 is stopped.

That is, by the controller 490 stopping driving the image projection module 470 by transmitting the disable signal to the image projection module 470, the laser beams corresponding to the predetermined image, which are projected onto the screen 130, are blocked.

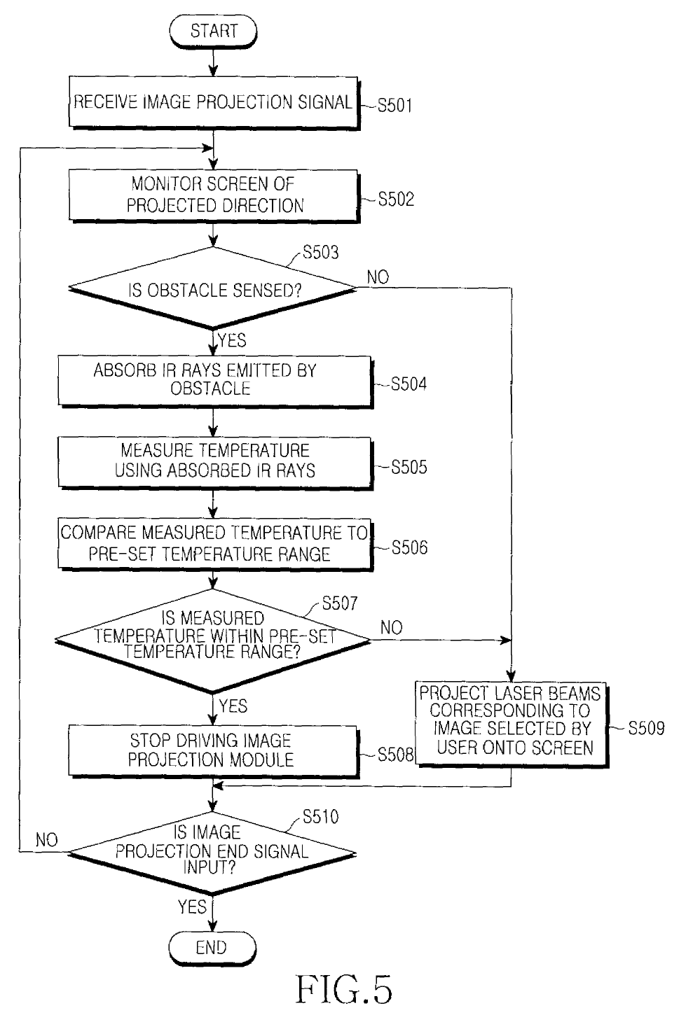

FIG. 5 is a flowchart illustrating a method of blocking laser beams using a human body sensor in an image projector according to an exemplary embodiment of the present invention.

Referring to FIG. 5, if an image projection signal for outputting a predetermined image selected by a user through the image projection module 470 is input to the controller 490 in step S501, in step S502, the controller 490 transmits the predetermined image selected by the user to the image projection module 470 and controls the sensor unit 480 to monitor in the direction of the screen 130 on which the image projection module 470 projects laser beams corresponding to the predetermined image.

When it is determined in step S503 that no obstacle exists in the projected direction in which the image projection module 470 projects onto the screen 130 the laser beams corresponding to the predetermined image, the controller 490 transmits the enable signal to the image projection module 470 in step S509 so that the image projection module 470 projects the laser beams corresponding to the predetermined image selected by the user onto the screen 130. The sensor unit 480 continuously monitors in the projected direction in which the image projection module 470 projects on the screen 130 the laser beams corresponding to the predetermined image.

When it is determined in step S503 that an obstacle exists in the projected direction in which the image projection module 470 projects on the screen 130 the laser beams corresponding to the predetermined image, the sensor unit 480 absorbs IR rays emitted by the sensed obstacle in step S504, wherein one of a pyroelectric and thermopile sensor, each of which is an IR sensor, is used as a sensor for absorbing the IR rays emitted by the sensed obstacle. In addition, by installing an optical filter in a window of the sensor unit 480, inputting of unnecessary wavelengths to the sensor is prevented so that the IR rays emitted by the obstacle can be absorbed well.

The sensor unit 480 measures a temperature value of the obstacle using the absorbed IR rays of the obstacle and transmits the measured temperature value to the controller 490 in step S505.

In an exemplary embodiment, a method for the sensor unit 480 to measure the temperature value of the obstacle is performed by quantifying a voltage proportional to a wavelength of the absorbed IR rays to a Celsius degree.

The controller 490 receives the measured temperature value from the sensor unit 480 and compares the received temperature value to a pre-set temperature range in step S506, wherein the pre-set temperature range is between 32° C. and 45° C.

When the received temperature value is within the pre-set temperature range in step S507, the controller 490 transmits the disable signal to the image projection module 470 in step S508 so that driving of the image projection module 470 is stopped, resulting in blocking of the laser beams corresponding to the predetermined image, which are projected onto the screen 130.

When the received temperature value is out of the pre-set temperature range in step S507, the controller 490 transmits the enable signal to the image projection module 470 in step S509 so that the image projection module 470 projects the laser beams corresponding to the predetermined image selected by the user onto the screen 130.

The sensor unit 480 continuously monitors in the direction in which the image projection module 470 projects on the screen 130 the laser beams corresponding to the predetermined image. That is, the sensor unit 480 continuously monitors in the projected direction in which the image projection module 470 projects on the screen 130 the laser beams corresponding to the predetermined image until the image projection using the image projection module 470 is terminated.

When no obstacle is sensed, the controller 490 controls the image projection module 470 to continuously project laser beams of a predetermined image selected by the user onto the screen 130, and When an obstacle is sensed, steps S504, S505, S506, and S507 are performed, and according to the result, the predetermined image is blocked from being projected or projected onto the screen 130.

When an image projection end signal is input by the user in step S510, the controller 490 ends operations of the image projection module 470 and the sensor unit 480.

That is, using the human body sensor 481 to monitor in a projected direction in which the image projection module 470 projects on the screen 120 laser beams corresponding to a predetermined image, and blocking the laser beams after checking a sensed obstacle when an obstacle is sensed in the projected direction, accidents related to safety of a human body can be previously prevented.

As described above, according to the present invention, by monitoring using a human body sensor in a projected direction in which an image projection module projects on a screen 130 laser beams corresponding to a predetermined image, and blocking the laser beams after checking a sensed obstacle when an obstacle is sensed in the projected direction, unnecessary blocking of laser beams can be prevented, and accidents related to safety of a human body can be previously prevented.

While the invention has been illustrated and described with reference to a certain exemplary embodiments thereof, it will be understood by those skilled in the art that various changes in form and details may be made therein without departing from the spirit and scope of the invention as defined by the appended claims.

What is claimed is:

1. A method of blocking laser beams using a human body sensor in an image projector, the method comprising the steps of:
monitoring to sense an obstacle, using the human body sensor, in a projected direction in which the image projector projects on a screen laser beams corresponding to a predetermined image;
when an obstacle is sensed in the projected direction, measuring a temperature value of the obstacle by absorbing infrared (IR) rays emitted by the obstacle;
comparing the measured temperature value of the obstacle to a pre-set temperature range; and
when the measured temperature value of the sensed obstacle is within the pre-set temperature range, blocking the laser beams corresponding to the predetermined image by stopping a driving of the image projector.

2. The method of claim 1, further comprising the step of when the measured temperature value of the sensed obstacle is outside of the pre-set temperature range, projecting the laser beams corresponding to the predetermined image onto the screen.

3. The method of claim 1, wherein the human body sensor comprises one of a pyroelectric sensor and a thermopile sensor, which is an IR sensor.

4. The method of claim 1, wherein the temperature value of the sensed obstacle is measured by quantifying a voltage proportional to a wavelength of the IR rays absorbed from the obstacle to a Celsius degree.

5. The method of claim 1, wherein the pre-set temperature range is between 32° C. and 45° C.

6. The method of claim 1, wherein the laser beams comprise a red (R) laser beam, a green (G) laser beam, and a blue (B) laser beam.

7. An apparatus for blocking laser beams using a human body sensor in an image projection module included in a mobile communication terminal, the apparatus comprising:
a sensor unit for monitoring in a projected direction in which the image projection module projects on a screen laser beams corresponding to a predetermined image to sense when an obstacle is present in the projected direction and when an obstacle is present for measuring a temperature value of the obstacle by absorbing infrared (IR) rays emitted by the obstacle, and outputting the measured temperature value;
a controller for receiving the measured temperature value from the sensor unit, comparing the measured temperature value to a pre-set temperature range, and if the measured temperature value of the obstacle is within the pre-set temperature range, outputting a signal for stopping driving the image projection module; and
the image projection module for receiving the signal for stopping driving the image projection module from the controller and stopping driving thereof.

8. The apparatus of claim 7, wherein the sensor unit comprises:
the human body sensor for monitoring in a projected direction in which the image projection module projects on the screen laser beams corresponding to a predetermined image, when an obstacle is sensed in the projected direction, for absorbing IR rays emitted by the obstacle, and for outputting a voltage proportional a wavelength of the IR rays absorbed from the obstacle; and
a temperature converter for receiving the voltage from the human body sensor and measuring a temperature value of the obstacle by quantifying the received voltage to a Celsius degree.

9. The apparatus of claim 8, wherein the human body sensor further comprises an optical filter in a window thereof the human body sensor absorbs the IR rays emitted by the obstacle through said optical filter.

10. The apparatus of claim 7, wherein the controller transmits one of an enable and disable signal to the image projection module according to a result obtained by comparing the measured temperature value of the obstacle to the pre-set temperature range.

11. The apparatus of claim 7, wherein the image projection module comprises:
a laser driver for receiving the enable or disable signal from the controller and determining according to the enable or disable signal whether the image projection module is driven; and
a laser light source module for projecting, when the image projection module is driven, laser beams corresponding to a predetermined image input from the controller onto the screen.

12. The apparatus of claim 7, wherein the predetermined image is selected from the group consisting of an image captured by a camera module included in the mobile communication terminal, an image downloaded from a base station in a wireless manner, and a multimedia data image received through a Digital Multimedia Broadcasting (DMB) service.

13. The apparatus of claim 7, wherein the mobile communication terminal is selected from the group consisting of a cellular phone, a personal information terminal, a Personal Communication Services (PCS) phone, an International Mobile Telecommunication (IMT)-2000 terminal, and a Global System for Mobile Communication (GSM) terminal, which comprises the image projection module.
